(19) United States
(12) Patent Application Publication
(10) Pub. No.: US 2026/0133564 A1
(43) Pub. Date: May 14, 2026

(54) OPTIMIZED COMMUNICATION BETWEEN EDGE APPLICATIONS AND CONTROL APPLICATION

(71) Applicant: ROCKWELL AUTOMATION TECHNOLOGIES, INC., MAYFIELD HEIGHTS, OH (US)

(72) Inventors: Joshua C. Seabloom, Upper Arlington, OH (US); Jason Yagielo, Asheville, NC (US); Adam F. Calhoon, Worthington, OH (US); Ryan J. Russell, Hillsboro, OR (US); Ashvin K. Kudva, Mayfield Heights, OH (US); Diane E. Golden, West Allis, WI (US); Paul C. Whitten, Munson Township, OH (US)

(21) Appl. No.: 19/378,112

(22) Filed: Nov. 3, 2025

Related U.S. Application Data
(60) Provisional application No. 63/720,317, filed on Nov. 14, 2024.

(51) Int. Cl. G05B 19/418; H04L 67/10

(52) U.S. Cl. CPC G05B 19/4185; G05B 19/41835; G05B 19/41875; H04L 67/10

(57) ABSTRACT

Systems, industrial devices, and methods for controlling communication within an industrial system. One system includes a PLC of the industrial system. The PLC may execute a control application to control performance of an industrial process of the industrial system. The control application may be locally stored at the PLC. The PLC may retrieve tag data related to performance of the industrial process, where the tag data may be specific to a tag related to performance of the industrial process. The PLC may route an electronic message including a portion of the tag data to an edge application subscribed to the tag. The edge application may be locally stored at the PLC. The PLC may execute the edge application based on the portion of the tag data such that the edge application performs an edge function related to the industrial system using the portion of the tag data.

### CROSS-REFERENCES TO RELATED APPLICATIONS

This claims priority to U.S. Provisional Application No. 63/720,317, filed Nov. 14, 2024, the entire contents of which is incorporated herein by reference.

### BACKGROUND

This disclosure relates to industrial environments and platforms such as industrial automation systems or manufacturing environments. Industrial manufacturing environments may include computing and mechanical systems configured to implement an industrial process. In industrial automation environments, control systems are used to drive various operations along an industrial line. Control programs are developed by programmers in integrated design applications. The integrated design applications may include programming tools to design control schemes for the industrial manufacturing environments. The control programs are used by control systems like Programmable Logic Controllers (“PLCs”) to drive the industrial assets, devices, and sensors in an industrial process. The integrated design applications communicate with numerous systems within industrial manufacturing environments like PLCs and orchestration systems. Integrated design applications may also communicate with external systems. The numerous communication links may create security vulnerabilities in the integrated design applications.

The discussion above is merely provided for general background information and is not intended to be used as an aid in determining the scope of the claimed subject matter.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

In some examples, the technology disclosed herein provides an industrial controller of an industrial system. The industrial controller may include a memory. The memory may include a control application that may control performance of an industrial process of the industrial system. The memory may include a set of edge applications that may perform edge functions related to the industrial system. The industrial controller may include a processor coupled to the memory. The processor may be configured to execute the control application to control performance of the industrial process of the industrial system. The processor may be configured to publish an electronic message including tag data related to execution of the control application, where the electronic message may be accessible to a subset of the set of edge applications such that each edge application included in the subset may perform a respective edge function using the tag data.

In some examples, the technology disclosed herein provides a method of controlling communication within an industrial system. The method may include executing, with an industrial controller of the industrial system, a control application to control performance of an industrial process of the industrial system, where the control application may be locally stored at the industrial controller. The method may include retrieving, with the industrial controller, tag data related to performance of the industrial process, where the tag data may be specific to a tag related to performance of the industrial process. The method may include routing, with the industrial controller, an electronic message including a portion of the tag data to an edge application subscribed to the tag, where the edge application may be locally stored at the industrial controller. The method may include executing, with the industrial controller, the edge application based on the portion of the tag data such that the edge application performs an edge function related to the industrial system using the portion of the tag data.

In some examples, the technology disclosed herein provides a system for controlling communication within an industrial system. The system may include a programmable logic controller (PLC) of the industrial system. The PLC may be configured to execute a control application to control performance of an industrial process of the industrial system, where the control application may be locally stored at the PLC. The PLC may be configured to retrieve tag data related to performance of the industrial process, where the tag data may be specific to a tag related to performance of the industrial process. The PLC may be configured to route an electronic message including a portion of the tag data to an edge application subscribed to the tag, where the edge application may be locally stored at the PLC. The PLC may be configured to execute the edge application based on the portion of the tag data such that the edge application performs an edge function related to the industrial system using the portion of the tag data.

The foregoing and other aspects and advantages of the present disclosure will appear from the following description. In the description, reference is made to the accompanying drawings which form a part hereof, and in which there is shown by way of illustrations one or more embodiments of the present disclosure. Such configurations do not necessarily represent the full scope of the present disclosure, however, and reference is made therefore to the claims and herein for interpreting the scope of the present disclosure.

### BRIEF DESCRIPTION OF DRAWINGS

The present disclosure will be better understood and features, aspects and advantages other than those set forth above will become apparent when consideration is given to the following detailed description thereof. Such detailed description makes reference to the following drawings.

FIG. 1 schematically illustrates a system for controlling communication within industrial systems according to some configurations.

FIG. 2 schematically illustrates an example industrial controller of an industrial system according to some configurations.

FIG. 3 illustrates an example workflow for an industrial controller according to some configurations.

FIG. 4 illustrates a flowchart of a method for controlling communication within industrial systems according to some configurations.

### DETAILED DESCRIPTION

As utilized herein, terms “component,” “system,” “controller,” “device,” “manager,” and variants thereof are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The disclosed technology is described with reference to the drawings, wherein like reference numerals are used to refer to like elements throughout. In the following description, for purposes of explanation, numerous specific details are set forth in order to provide a thorough understanding of the disclosed technology. It may be evident, however, that the disclosed technology may be practiced without these specific details. In other instances, well-known structures and devices are shown in block diagram form in order to facilitate describing the disclosed technology.

As noted herein, the technology disclosed herein relates generally to industrial systems, and, more particularly, to communication between edge application and control applications for industrial systems. While the technology disclosed herein is described with respect to communication between edge applications and control applications, and, in some instances, communication between edge applications and control applications for industrial systems, the technology disclosed herein may be implemented or applied to other technologies, fields, use cases, industries, etc.

The technology disclosed herein is related to systems and methods for software defined automation (SDA), and more specifically, to SDA related to a programmable logic controller (PLC).

For instance, the technology disclosed herein involves optimizing communications between industrial workload entities by co-locating workload service (e.g., same operating system (OS) or same device) and leveraging optimized communication techniques (e.g., shared memory and interprocess communications) as well as data model optimization (e.g., compression or caching) or serialization optimization techniques to reduce the communication cost.

Industrial workloads may consist of distributed services and entities hosted in differing compute environments. There is a communication cost associated with a distributed workload from the communication between the processes and/or devices hosting the services and entities. The communication cost can be significant.

Edge applications and workloads may provide or generate data that may be useful to the control application, such as, e.g., sensor feedback, imputed data (e.g., data calculated or inferred from sensor feedback), classification data, etc. It is desired to enable optimized communication between the control application and the edge applications (e.g., motion, vision, HMI, data gateway, webserver, historian, predictive modeling, etc.) when hosting the edge applications and the control application on shared hardware (e.g., a PLC).

As described in greater detail herein, data (e.g., tags) from a control application may be efficiently shared with one or more edge applications. For instance, in some configurations, the technology disclosed herein may share such data using, e.g., highly optimized local or other computing techniques, such as, e.g., shared memory, interprocess communications, message queues, compression, aggregation of multiple requests for the same data, etc. Edge application(s) may have the ability to efficiently read, write, and subscribe to data (e.g., tags) in the control application. The control application and the edge application(s) may run in different languages. With the communication mechanism described herein, seamless sharing of data is enabled.

In some configurations, additional communication efficiencies may be achieved. For example, in some configurations, the technology disclosed herein may leverage a shared data model across design, execution, and data access in order to achieve additional communication efficiencies. Such a data model may be constructed and optimized to address particular concerns of a system, such as, e.g., size on a wire, data compression, schema evolution, ability to support generic user-defined data types (UDT), rapid/efficient serialization for preserving data during power loss, etc.

In some instances, edge workloads (or applications) and the control application may have different access levels to the data. In some examples, an application may be comprised of one or more workloads, processes, or services that provide capabilities across one or more other applications. For example, edge workload(s) can only read the data while the control application can read and write the data. Additionally, different users interacting with the edge workloads may have different access levels of permissions for create, read, update, or delete (CRUD) operations to different portions of the data. The technology disclosed herein may enforce such access restrictions based on, e.g., security policy settings on the data items (e.g., read, read/write, or no access for edge applications). The data access mechanism described herein may further apply to the access based on user roles.

In some configurations, the optimized communication mechanism described herein may be further extended and leveraged to allow third-party applications to provide or contribute tag data to the ecosystem on or off the PLC.

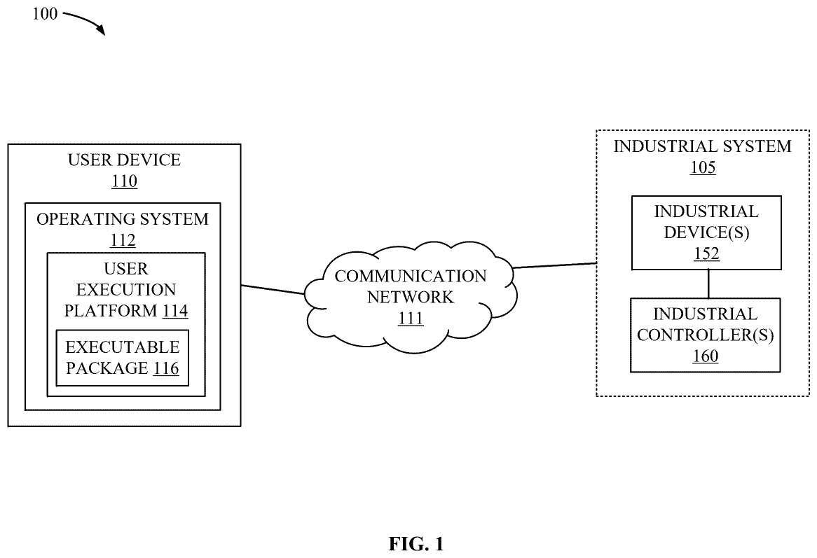

FIG. 1 schematically illustrates an example system 100 for controlling communication between one or more edge applications and a control application for industrial systems according to some configurations. In the illustrated example, the system 100 may include an industrial system 105 and a user device 110. In some configurations, the system 100 includes fewer, additional, or different components in different configurations than illustrated in FIG. 1. As one example, the system 100 may include multiple industrial systems 105, multiple user devices 110, or a combination thereof. As another example, one or more components of the system 100 may be combined into a single device. Alternatively, or in addition, in some configurations, the user device 110 may be included as part of the industrial system 105 (e.g., as a component of the industrial system 105).

The industrial system 105 and the user device 110 may communicate over one or more wired or wireless communication networks 111. Portions of the communication networks 111 may be implemented using a wide area network, such as the Internet, a local area network, such as BLUETOOTH® or WI-FI®, and combinations or derivatives thereof. Alternatively, or in addition, in some configurations, components of the system 100 may communicate directly as compared to through the communication network 111. Also, in some configurations, the components of the system 100 may communicate through one or more intermediary devices not illustrated in FIG. 1.

The user device 110 may also include a computing device, such as a desktop computer, a laptop computer, a tablet computer, a terminal, a smart telephone, a smart television, a smart wearable, or another suitable computing device that interfaces with a user. In some examples, the user device 110 may be included as a component of the industrial system 105, such as, e.g., an HMI of the industrial system 105. However, in some configurations, such as the configuration illustrated in FIG. 1, the user device 110 may be separate or remote from the industrial system 105.

In some configurations, the user device 110 may be an industrial personal computer (PC). An industrial PC is a computing device that is specifically designed or otherwise configurated for user in industrial environments (e.g., harsh or rugged environments relative to a traditional office setting). For instance, industrial PCs may be specifically designed for continuous operation (e.g., 24/7), extreme or severe environmental conditions (e.g., temperatures, vibrations, electric noise, dust, moisture, etc.), etc. Such industrial PCs may be configured to facilitate control or operations related to an industrial process of the industrial system 105. For example, an industrial PC may perform operations or functionality related to factory automation, machine vision systems, robotics control, data logging or monitoring, etc.

As illustrated in FIG. 1, the user device 110 may include an operating system (OS) 112. The OS 112 may include a user execution platform 114. The user execution platform 114 may be used to create an executable package 116. The OS 112 can include any suitable types of processing circuitry (e.g., one or more central processing units (CPUs), one or more graphics processing units (GPUs), one or more application specific integrated circuits (ASICs), one or more field-programmable gate arrays (FPGAs), etc.) with any suitable configuration of processing cores. In some examples, the user device 110 may further include any suitable types of memory (e.g., volatile, non-volatile, random-access memory (RAM), read-only memory (ROM), electrically erasable programmable read-only memory (EEPROM), etc.).

In some examples, the user execution platform 114 may provide a user with a configurable environment for software development. For example, the user execution platform 114 may include grouped project folders, configurable settings, extensions, or the like, that allow a user to develop workloads. In some examples, the user execution platform 114 may allow a user to create the executable package 116 for a given workload. For example, the executable package 116 can include a docker image containing code, libraries, variables, etc. for running a corresponding workload. In some examples, the workload of the executable package 116 may define an application to be run with respect to the industrial system 105. In some instances, the application may be an edge application that performs an edge workload related to an industrial process of the industrial system 105. For example, the application (or edge application) may include a motion application, a vision application, a human-machine interface (HMI) application, a data gateway, a webserver, a historian application, a predictive modeling application, or the like.

Although not illustrated in FIG. 1, the user device 110 may include similar components as the industrial controller 160, such as electronic processor (e.g., a microprocessor, an ASIC, or another suitable electronic device), a memory (e.g., a non-transitory, computer-readable storage medium), a communication interface, such as a transceiver, for communicating over the communication network 111 and, optionally, one or more additional communication networks or connections, and one or more human machine interfaces. For example, to communicate with the industrial system 105 (or one or more industrial devices 152 or industrial controllers 160 thereof), the user device 110 may store a browser application or a dedicated software application executable by an electronic processor. In some configurations, the user device 110 includes additional, fewer, or different components than the industrial controller 160. As noted herein, the functionality (or a portion thereof) described herein as being performed by the user device 110 may be performed by another device of the system 100, distributed among multiple devices of the system 100, combined with another component of the system 100, or a combination thereof. For example, in some configurations, the functionality (or a portion thereof) described as being performed by the user device 110 may be performed by the industrial device(s) 152, the industrial controller(s) 160, another component of the system 100 or industrial system 105, or a combination thereof.

The industrial system 105 may be a manufacturing system, such as, e.g., an industrial automation system or the like. The industrial system 105 may be associated with (or located at) a facility or site. In some configurations, a facility or site may include multiple industrial systems 105 (e.g., a first industrial system, a second industrial system, a third industrial system, etc.). Accordingly, in some configurations, the industrial system 105 may be implemented at a facility. Alternatively, or in addition, in some configurations, the system 100 may include a first industrial system located at a first facility and a second industrial system located as a second facility different from the first facility. The industrial system 105 may be configured to perform one or more industrial processes, manufacturing processes, production processes, automation processes, or the like. In some configurations, the industrial system 105 may perform a production method that produces goods or products. As one example, the industrial system 105 may perform a vehicle manufacturing process to assemble or produce a vehicle (or various components thereof). As another example, the industrial system 105 may perform a food manufacturing process for making a food product. As yet another example, the industrial system 105 may perform a pharmaceutical manufacturing process for producing pharmaceuticals.

As such, in some configurations, the industrial system 105 can be used to execute or automate manufacturing processes in industries such as, e.g., aerospace, automotive, cement, chemical processing, food and beverage, household and personal care, life sciences, marine operations, metals processing, mining operations, oil and gas, power generation, print and publishing, pulp and paper, semiconductors, warehouse and fulfillment, and wastewater treatment, among others.

In the illustrated example, the industrial system 105 may include one or more industrial devices 152 (referred to herein collectively as “the industrial devices 152” and individually as “the industrial device 152”). The industrial device(s) 152 may be a physical piece of equipment included in the industrial system 105. For example, an industrial device 152 may include a pump, a press, a conveyor, a valve, a switch, a motor, a motion device, a sensor, a server, a database, a human-machine interface (“HMI”), another piece of equipment that may be used in connection with an associated industrial process or application of the industrial system 105, or the like.

As illustrated in FIG. 1, in some configurations, the industrial system 105 may include one or more industrial controllers 160 (referred to herein collectively as “the industrial controllers 160” and individually as “the industrial controller 160”). The industrial controller 160 may be a programmable logic controller (PLC). In some specific examples, the industrial controller 160 may be a software defined automation (SDA) PLC (e.g., a PLC configured to implement or otherwise facilitate functions or functionality related to SDA). As described herein, the industrial controller 160 may facilitate (or otherwise control) performance of an industrial process (or portion(s) thereof) with respect to the industrial system 105.

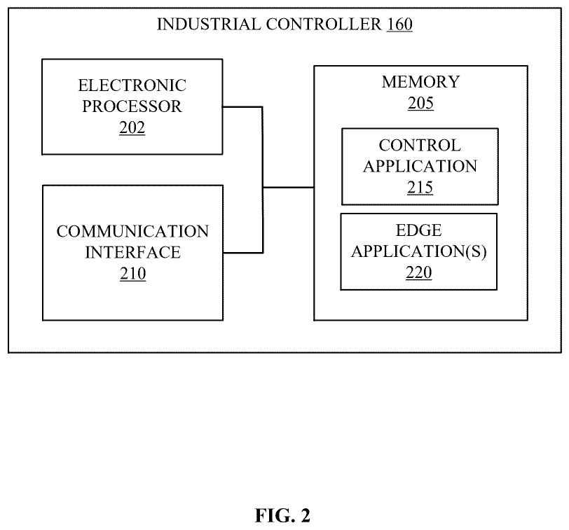

FIG. 2 illustrates an example industrial controller 160 of the industrial system 105. As illustrated in FIG. 2, the industrial controller 160 may include an electronic processor 202, a memory 205, and a communication interface 210. The electronic processor 202, the memory 205, and the communication interface 210 may communicate wirelessly, over one or more communication lines or buses, or a combination thereof. The industrial controller 160 may include additional, different, or fewer components than those illustrated in FIG. 2 in various configurations. The industrial controller 160 may also perform additional or different functionality other than the functionality described herein.

The communication interface 210 may include a transceiver that communicates with the industrial system 105 (e.g., the industrial device(s) 152 of the industrial system 105, another component or device of the industrial system 105, etc.), the user device 110, or a combination thereof over the communication network 111 and, optionally, one or more other communication networks or connections. In some examples, the communication interface 210 can further include a software defined mechanism that may allow for zero or minimal copy techniques in order to optimize data communication with the industrial system 105. In some configurations, the communication interface 210 enables the industrial controller 160 to communicate with the industrial system 105 (e.g., the industrial device(s) 152 of the industrial system 105), the user device 110, or a combination thereof over one or more wired or wireless connections. The electronic processor 202 may include a microprocessor, an application-specific integrated circuit (“ASIC”), or another suitable electronic device for processing data, and the memory 205 includes a non-transitory, computer-readable storage medium. The electronic processor 202 is configured to retrieve instructions and data from the memory 205 and execute the instructions.

For example, as illustrated in FIG. 2, the memory 205 may include a control application 215. The control application 215 may be a control program or logic of the industrial controller 160. In some cases, the control application 215 may control (or otherwise facilitate) a real-time (or near real-time) operation of the industrial system 105 (or industrial process(es) performed thereby). For instance, the control application 215 may include one or more executable instructions that implement (or otherwise) control implementation or execution of an industrial process (or portion(s) thereof) of the industrial system 105. In some instances, the control application 215 may be in a programming language specific for industrial controls or PLCs (e.g., a PLC programming language), such as, e.g., ladder logic, function block diagram, structured text, sequential function chart, etc.

In some examples, the control application 215 may control performance of various functions (or logic) by one or more of the industrial devices 152 (e.g., drive industrial assets, devices, or sensors in an industrial process of the industrial system 105). In some instances, the control application 215 may relate to, e.g., a monitoring process, an automation process, a data acquisition process, a sequence management process, an error detection process, a fault detection process, etc. For example, the control application 215 may include one or more operations related to the industrial device(s) 152, such as, e.g., one or more switching operations, load isolation operations, signal routing operations, torque control operations, acceleration control operations, deceleration control operations, or the like. In some instances, execution of the control application 215 (or portion(s) thereof) may involve (or otherwise include) one or more logic functions. For example, the electronic processor 202 may perform (or otherwise execute) a logic function to execute the control application 215 (or portion(s) thereof). As one example, the control application 215 may include a routine involving a sequence of logic to be executed as a block (e.g., a sequence of one or more logic functions). Following this example, to execute the control application 215, the electronic processor 202 may execute the routine by executing the sequence of logic of that routine.

As illustrated in FIG. 2, the control application 215 is included in the memory 205 of the industrial controller 160. However, in some configurations, the control application 215 (or portion(s) thereof), may be included in a separate device accessible by the industrial controller 160 (included in the industrial controller 160 or external to the industrial controller 160).

In the illustrated example of FIG. 2, in some configurations, the memory 205 may include one or more edge applications 220 (referred to herein collectively as “the edge applications 220” and individually as “the edge application 220”). As described herein, the edge application(s) 220 may include (or otherwise involve) computing workloads of an end-user (also referred to herein as “edge workloads”). For instance, the edge application(s) 220 may include workloads related to (or otherwise involving), e.g., motion, vision, data acquisition, human-machine interface (HMI), historian, analytics, artificial intelligence (AI) inference and machine learning, predictive modeling, autonomous mobile robot (AMR) applications, etc. As such, in some instances, the edge application(s) 220 may be an analytics application, a historian application, a data acquisition application, a motion application, an HMI application, etc. As described herein, in traditional implementations, such edge applications typically reside on edge or supplemental computing devices, such as, e.g., the user device 110, an industrial PC, another component or device of the industrial system 105, etc. In some instances, the edge application(s) 220 may be in a general-purpose programming language (e.g., a programming language that is not specific to industrial controllers or PLCs), such as, e.g., Python, C, C++, Java, etc. As such, in some instances, the control application 215 may be in a first programming language while the edge application(s) 220 may be in a second programming language different than the first programming language.

As described herein, the system 100 may facilitate (or otherwise control) communication between the control application(s) 215 and the edge application(s) 220, such as, e.g., when the edge application(s) 220 and the control application(s) 215 are hosted on shared hardware, such as the industrial controller 160 (e.g., a PLC). As described herein, the edge application(s) and workloads (e.g., the edge application(s) 220) may provide or generate data that may be utilized by the control application(s) 215, such as sensor feedback, imputed data (e.g., data calculated/inferred from sensor feedback), and classification data. Accordingly, in some cases, the edge application(s) 220 may interact with data (or tag(s)) of the control application(s) 215. For example, the edge application(s) 220 may read, write, read and write, or subscribe to the data or tags of the control application(s) 215.

As used herein, a “tag” may represent data. For instance, a tag may be a named variable that stores data in a controller (e.g., the industrial controller 160). In some examples, a tag may represent a physical input or output (e.g., of a sensor, an actuator, another industrial device 152 of the industrial system 105, etc.), an internal logic value (e.g., of a counter, a timer, a flag, etc.), structured data (e.g., arrays, user-defined types, etc.), etc. In some cases, a tag may have one or more attributes, such as, e.g., a name, a data type, a scope, a value, a property, etc. As one example, the tag(s) may be live data that is calculated on each scan of a program (e.g., the edge application(s) 220, the control application(s) 215, etc.). As another example, the tag(s) may be process data. In some instances, the tag(s) may represent data that may contribute to future workloads.

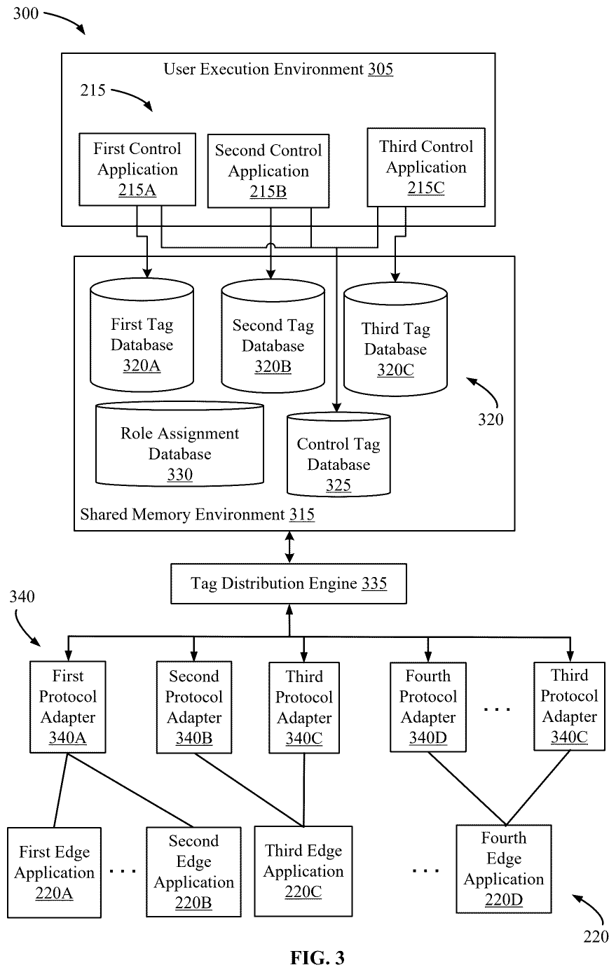

FIG. 3 illustrates an example workflow 300 according to some configurations. For instance, FIG. 3 illustrates communication between various components (or environments) of the system 100, such as, e.g., components (or environments) of the industrial controller 160.

FIG. 3 includes a user execution environment 305. In some instances, the user execution environment 305 may be a user execution platform or environment of the industrial controller 160. For example, the user execution environment 305 may be local to the industrial controller 160. As illustrated in FIG. 3, the user execution environment 305 may include one or more of the control applications 215. For example, the user execution environment 305 may include a first control application 215A, a second control application 215B, and a third control application 215C. As such, the user execution environment 305 may host or otherwise execute (or run) the control applications 215 (or portion(s) thereof), such as, e.g., as part of performing (or otherwise controlling) an industrial process or component(s) of the industrial system 105 (e.g., the industrial device(s) 152).

As illustrated in FIG. 3, the user execution environment 305 may communicate with a shared memory environment 315. In some instances, the shared memory environment 315 may be local to the industrial controller 160. For example, in some configurations, the shared memory environment 315 may be (or otherwise be part of) the memory 205 of the industrial controller 160. As illustrated in FIG. 3, the shared memory environment 315 may include one or more tag databases 320. The tag database(s) 320 may store tag data, such as, e.g., one or more tags, information or data related to the tag(s), etc. In some instances, each of the tag database(s) 320 may store tag data specific to a particular tag, a particular control application, etc. For example, in some configurations, the shared memory environment 315 may include a corresponding tag database for a respective control application. For instance, in the example of FIG. 3, the shared memory environment 315 may include a first tag database 320A that stores tag data related to the first control application 215A, a second tag database 320B that stores tag data related to the second control application 215B, and a third tag database 320C that stores tag data related to the third control application 215C. As described herein, the user execution environment 305 (or the control applications 215 therein) may communicate tag data to the shared memory environment 315 (or the tag database(s) 320 therein), such as, e.g., the first tag database 320A, the second tag database 320B, the third tag database 320C, etc.

As illustrated in FIG. 3, in some configurations, the shared memory environment 315 may include a control tag database 325. The control tag database 325 may include information or data related to access control permissions. For instance, in some configurations, the control application(s) 215 and the edge application(s) 220 may have different access levels to the tag data. For example, the edge application(s) 220 may only read the tag data while the control application 215 can read and write the tag data. Accordingly, in some instances, the control tag database 325 may include access control permissions (or data related thereto) associated with the control application(s) 215, the edge application(s) 220, etc. As illustrated in the example of FIG. 3, in some configurations, the control tag database 325 may communicate with each of the control applications 215 (e.g., the first control application 215A, the second control application 215B, the third control application 215C, etc.). Accordingly, in some configurations, the control tag database 325 may include access control permissions (or data related thereto) related to multiple control applications 215 (e.g., each of the control applications 215 included within the user execution environment 305 of the industrial controller 160).

Alternatively, or in addition, in some configurations, the shared memory environment 315 may include a role assignment database 330. The role assignment database 330 may include information or data related to access levels or permissions for various users. For instance, in some configurations, different users interacting with the workloads (e.g., the edge application(s) 220, the control application(s) 215, etc.) may have different access levels of permissions for create, read, update, and delete (CRUD) operations to different portions of the tag data. In some configurations, the optimized communication system described herein may enforce these access restrictions based on security policy settings on the data items: read, read/write, or no access for the edge application(s) 220. In some instances, the data access mechanism may further apply to the access based on user roles.

As illustrated in FIG. 3, the shared memory environment 315 may be accessible to a tag distribution engine 335. The tag distribution engine 335 may facilitate or otherwise implement an edge tag link or distribution service. For instance, the tag distribution engine 335 may control (or otherwise facilitate) the distribution of tag data (e.g., tag(s)) to one or more the edge applications 220. Accordingly, in some configurations, the tag distribution engine 335 may interact with the shared memory environment 315 in order to access data (e.g., tag data or tag(s)) from, e.g., one or more of the databases of the shared memory environment 315 (e.g., the first tag database 320A, the second tag database 320B, the third tag database 320C, the control tag database 325, the role assignment database 330, etc.). As one specific example, the tag distribution engine 335 may access tag data (e.g., the tag(s)) from the first tag database 320A and publish (or distribute) the tag data for one or more of the edge applications 220. In some instances, the tag distribution engine 335 may publish a single message related to the tag data such that the edge application(s) 220 subscribed to that tag may receive the tag data (via the single message) (as opposed to the tag distribution engine 335 publishing (or otherwise distributing) multiple. repetitive messages to the edge application(s) 220 subscribed to that tag).

As illustrated in FIG. 3, in some configurations, the tag distribution engine 335 may distribute (or otherwise publish) tag data to the edge applications 220 via one or more protocol adapters 340. In some configurations, the protocol adapter(s) 340 may be hosted as workloads within an edge framework such that the protocol adapter(s) 340 may access the tag data via the tag distribution engine 335. The protocol adapter(s) 340 may convert (or otherwise modify) tag data. For instance, as described herein, in some instances, the control application(s) 215 and the edge application(s) 220 may be in different programming languages. As such, in some configurations, the protocol adapter(s) 340 may convert (or otherwise modify) tag data such that the tag data may comply with a particular protocol of a receiving application (e.g., the edge application 220 receiving the tag data). A protocol may include, e.g., a message queuing telemetry transport (MQTT) protocol; a JavaScript Object Notation (JSON) protocol; a neural autonomic transport system (NATS) protocol; a data distribution service (DDS) protocol; a robot operating system (ROS) protocol; an open platform communications unified architecture (OPC UA) protocol; or a common industrial protocol (CIP); etc. As one specific example, when the receiving application is an analytics edge application (e.g., the first edge application 220A), the tag data may be provided to the analytics edge application via an MQTT or JSON protocol adapter (e.g., the first protocol adapter 340A). In some instances, the same protocol adapter may be applicable to multiple different receiving applications. For example, as illustrated in FIG. 3, the first protocol adapter 340A may be applicable to the first edge application 220A and the second edge application 220B. Alternatively or in addition, in some instances, multiple protocol adapters may be applicable to a single receiving application. For example, as illustrated in FIG. 3, the second protocol adapter 340B and the third protocol adapter 340C may be applicable to the third edge application 220C.

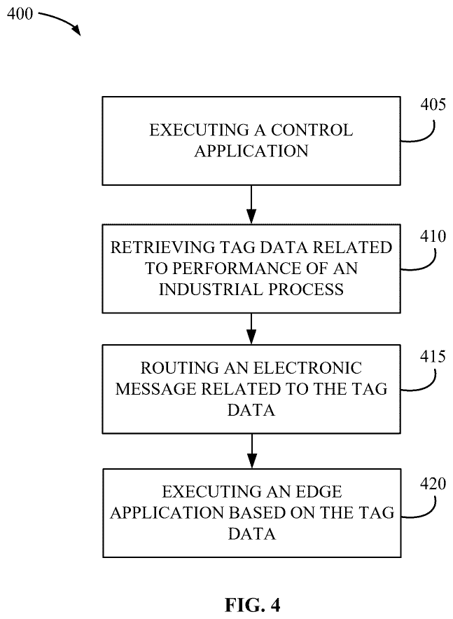

FIG. 4 is a flowchart illustrating a method 400 for controlling communication within industrial systems according to some configurations. In some examples, controlling communication with industrial systems may include optimizing communication processes and/or systems. The method 400 is described as being performed by industrial controller 160 (e.g., the electronic processor 202). However, as noted herein, the functionality described with respect to the method 400 may be performed by other devices, such as the industrial device(s) 152, the user device 110, another industrial device, another component included in the industrial system 105, or a combination thereof, distributed among a plurality of devices, such as a plurality of servers included in a cloud service, or a combination thereof. As described below, a particular implementation can omit some or all illustrated features/steps, may be implemented in some embodiments in a different order, and may not involve some illustrated features to implement all embodiments.

As illustrated in FIG. 4, the industrial controller 160 may execute the control application(s) 215(at block 405). As described in greater detail herein, the industrial controller 160 may execute the control application(s) 215 in order to control performance of an industrial process of the industrial system 105. As also described herein, in some configurations, the control application(s) 215 may be stored locally at the industrial controller 160 (e.g., in the memory 205, as illustrated in FIG. 2).

In some instances, the industrial controller 160 may store tag data related to performance of the industrial process of the industrial system 105 (e.g., related to execution of the control application(s) 215). For instance, with reference to FIG. 3, in some cases, the tag data may be stored in the shared memory environment 315, such as, e.g., one or more of the tag databases 320.

The industrial controller 160 may retrieve tag data related to performance of the industrial process (at block 410). In some cases, the tag data may be related to execution of the control application(s0 215. As described herein, the tag data may include information or data related to one or more tag(s). As such, in some configurations, the tag data may be specific to a tag related to performance of the industrial process. With reference to FIG. 3, in some instances, the tag data may be retrieved from one or more of the tag databases 320, such as, e.g., by the tag distribution engine 335.

The industrial controller 160 may route (or otherwise publish) an electronic message related to the tag data (at block 415). In some instances, the electronic message may include the tag data (or portions thereof). In some cases, the electronic message may be generated and distributed (or routed) as described herein with respect to the tag distribution engine 335 of FIG. 3. In some examples, the industrial controller 160 may route the message in an optimized manner. For instance, in some configurations, the industrial controller 160 may route the electronic message to one or more of the edge applications 220. As one example, the industrial controller 160 may route the electronic message to an edge application subscribed to the tag related to the tag data.

In some configurations, the industrial controller 160 may enforce an access control permission, a user role permission, etc. For example, in some configurations, the industrial controller 160 may enforce one or more access control permissions related to the tag data (or portion(s) thereof). In some configurations, the industrial controller 160 (e.g., the tag distribution engine 335) may enforce the access control permission(s) related to the tag data by enforcing a read permission, a write permission, or a read-write permission with respect to the tag data. As another example, in some configurations, the industrial controller 160 may enforce one or more user role permissions related to the tag data (or portion(s) thereof). In some configurations, the industrial controller 160 (e.g., the tag distribution engine 335) may enforce user role permission(s) related to the tag data. For instance, the user role permission(s) may be specific to a user. In some examples, the user role permission(s) may define access level of permission(s) related to create, read, update, and delete (CRUD) operations. With reference to FIG. 3, in such configurations, the industrial controller 160 (e.g., the tag distribution engine 335) may interact with the role assignment database 330, the control tag database 325, or a combination thereof in order to enforce the access control permission(s), the user role permission(s), etc., as described herein.

As described in greater detail herein, in some configurations, the tag data may be provided to the edge application(s) 220 via one or more protocol adapters 340. Accordingly, in some configurations, the industrial controller 160 may convert (or otherwise transform) the tag data (or portion(s) thereof) from a first protocol to a second protocol (e.g., where the first protocol and the second protocol are different). As one example, in some configurations, the industrial controller 160 may convert the tag data (or portion(s) thereof) from a protocol of the control application (e.g., a first protocol) to a protocol of the edge application(s) 220 (e.g., a second protocol). As another example, in some configurations, the industrial controller 160 may convert the tag data (or portion(s) thereof) from a protocol of the edge application(s) 220 (e.g., a second protocol) to a protocol of the control application (e.g., a first protocol). As such, in some configurations, the tag data may be converted (or otherwise transformed) such that a format of the tag data complies with a protocol of a receiving application (e.g., a receiving edge application, a receiving control application, etc.).

The industrial controller 160 may execute the edge application(s) 220 (at block 420). In some instances, the industrial controller 160 may execute the edge application(s) 220 based on tag data (or portion(s) thereof). As described herein, the edge application(s) 220 may perform an edge function related to the industrial system 105 using the tag data (or portion(s) thereof). For instance, the edge application 220 may perform an edge function on or otherwise with respect to the tag data or otherwise be based on the tag data.

What has been described above includes examples of the disclosed technology. It is, of course, not possible to describe every conceivable combination of components or methodologies for purposes of describing the disclosed technology, but one of ordinary skill in the art may recognize that many further combinations and permutations of the disclosed technology are possible. Accordingly, the disclosed technology is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed technology. In this regard, it will also be recognized that the disclosed technology includes a system as well as a computer-readable medium having computer-executable instructions for performing the acts and/or events of the various methods of the disclosed technology.

In addition, while a particular feature of the disclosed technology may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. An industrial controller of an industrial system, the industrial controller comprising:
a memory storing:
a control application that controls performance of an industrial process of the industrial system, and
a set of edge applications that perform edge functions related to the industrial system; and
a processor coupled to the memory, the processor configured to:
execute the control application to control performance of the industrial process of the industrial system; and
publish an electronic message including tag data related to execution of the control application, wherein the electronic message is accessible to a subset of the set of edge applications such that each edge application included in the subset performs a respective edge function using the tag data.

2. The industrial controller of claim 1, wherein the edge application includes at least one of: an analytics application, a historian application, a motion application, a communication application; or a human-machine interface (HMI) application.

3. The industrial controller of claim 1, wherein the one or more edge applications are subscribed to a tag corresponding to the tag data.

4. The industrial controller of claim 1, wherein the industrial controller is a programmable logic controller (PLC).

5. The industrial controller of claim 1, wherein the control application controls a real-time operation of the industrial system.

6. The industrial controller of claim 1, wherein the control application is in a first programming language and a first edge application of the subset is in a second programming language different from the first programming language.

7. The industrial controller of claim 6, wherein the processor is configured to convert the tag data such that a format of the tag data complies with a protocol of the first edge application of the subset.

8. The industrial controller of claim 1, wherein the processor is configured to enforce an access control permission related to the tag data.

9. The industrial controller of claim 1, wherein the processor is configured to enforce a user role permission related to the tag data.

10. The industrial controller of claim 1, wherein the processor is configured to execute each edge application included in the subset using the tag data.

11. A method of controlling communication within an industrial system, the method comprising:
executing, with an industrial controller of the industrial system, a control application to control performance of an industrial process of the industrial system, wherein the control application is locally stored at the industrial controller;
retrieving, with the industrial controller, tag data related to performance of the industrial process, wherein the tag data is specific to a tag related to performance of the industrial process;
routing, with the industrial controller, an electronic message including a portion of the tag data to an edge application subscribed to the tag, wherein the edge application is locally stored at the industrial controller; and
executing, with the industrial controller, the edge application based on the portion of the tag data such that the edge application performs an edge function related to the industrial system using the portion of the tag data.

12. The method of claim 11, further comprising:
converting, with the industrial controller, the portion of the tag data from a first protocol of the control application to a second protocol of the edge application, wherein the first protocol and the second protocol are different.

13. The method of claim 12, wherein adapting, with the industrial controller, the portion of the tag data to the protocol of the edge application includes adapting the portion of the tag data to at least one of: a message queuing telemetry transport (MQTT) protocol; a JavaScript Object Notation (JSON) protocol; a neural autonomic transport system (NATS) protocol; a data distribution service (DDS) protocol; a robot operating system (ROS) protocol; an open platform communications unified architecture (OPC UA) protocol; or a common industrial protocol (CIP).

14. The method of claim 11, further comprising:
storing, with the industrial controller, the tag data in a shared memory of the industrial controller.

15. A system for controlling communication within an industrial system, comprising:
a programmable logic controller (PLC) of the industrial system, the PLC configured to:
execute a control application to control performance of an industrial process of the industrial system, wherein the control application is locally stored at the PLC;
retrieve tag data related to performance of the industrial process, wherein the tag data is specific to a tag related to performance of the industrial process;
route an electronic message including a portion of the tag data to an edge application subscribed to the tag, wherein the edge application is locally stored at the PLC; and
execute the edge application based on the portion of the tag data such that the edge application performs an edge function related to the industrial system using the portion of the tag data.

16. The system of claim 15, wherein the PLC is further configured to:
route the electronic message to a second edge application subscribed to the tag, wherein the second edge application is locally stored at the PLC; and
execute the second edge application based on the portion of the tag data such that the second edge application performs a second edge function related to the industrial system using the portion of the tag data.

17. The system of claim 15, wherein the edge application includes at least one of: an or a human-machine interface (HMI) application.

18. The system of claim 15, wherein the PLC is configured to:
convert the portion of the tag data from a first protocol of the control application to a second protocol of the edge application, wherein the first protocol and the second protocol are different.

19. The system of claim 15, wherein the PLC is configured to:
enforce an access control permission related to the tag data, wherein the access control permission includes at least one of: a read permission; a write permission; or a read-write permission.

20. The system of claim 15, wherein the PLC is configured to:
enforce a user role permission related to the tag data, wherein the user role permission is specific to a user and defines an access level of permission related to create, read, update, and delete (CRUD) operations.
